(19) United States
(12) Patent Application Publication
(10) Pub. No.: US 2023/0119700 A1
(43) Pub. Date: Apr. 20, 2023

(54) ADHESIVE SHEET AND LAMINATE

(71) Applicant: LINTEC CORPORATION, Tokyo (JP)

(72) Inventors: Minami NAKANISHI, Tokyo (JP); Yutaka NANASHIMA, Tokyo (JP)

(73) Assignee: LINTEC CORPORATION, Tokyo (JP)

(21) Appl. No.: 17/914,473

(22) PCT Filed: Dec. 2, 2020
(86) PCT No.: PCT/JP2020/044898

§ 371 Date: Sep. 26, 2022

(30) Foreign Application Priority Data
Mar. 25, 2020 (JP) 2020-053911

(51) Int. Cl. C09J 7/38; C09J 7/10; C09J 133/14; B32B 7/12

(52) U.S. Cl. CPC C09J 7/385; C09J 7/10; C09J 133/14; B32B 7/12; C09J 2301/312; B32B 27/308

(57) ABSTRACT

An adhesive sheet comprising at least a pressure sensitive adhesive layer, wherein the adhesive sheet has an adhesive strength to soda-lime glass of larger than 1 N/25 mm and 100 N/25 mm or less, a pressure sensitive adhesive that constitutes the pressure sensitive adhesive layer is formed of a pressure sensitive adhesive composition that contains a (meth)acrylic ester polymer (A), and the (meth)acrylic ester polymer (A) contains, as a monomer unit that constitutes the polymer, an ethylene carbonate-containing monomer having an ethylene carbonate structure represented by Formula (1) below.

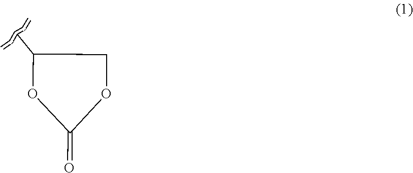

### TECHNICAL FIELD

The present invention relates to an adhesive sheet and a laminate that are suitable for the use for a display body (display).

### BACKGROUND ART

Various mobile electronic devices such as smartphones and tablet terminals in recent years are equipped with displays using display body modules having liquid crystal elements, light emitting diodes (LED elements), organic electroluminescence (organic EL) elements, etc., and such displays may often serve as touch panels.

In such a display as above, a protective panel is usually provided on the surface side of the display body module. Along with the reduction in thickness/weight of electronic devices, the above protective panel has been changed from the conventional glass plate to a plastic plate such as an acrylic plate or a polycarbonate plate.

Here, an air gap is provided between the protective panel and the display body module so that even when the protective panel is deformed due to external force, the deformed protective panel does not collide with the display body module.

When an air gap as above or an air layer exists, however, the reflection loss of light due to a refractive index difference between the protective panel and the air layer and a refractive index difference between the air layer and the display body module is large, and there is a problem in that that the image quality of display deteriorates.

To overcome this problem, it has been proposed to improve the image quality of display by filling the air gap between the protective panel and the display body module with a pressure sensitive adhesive layer. For example, Patent Document 1 discloses, as the pressure sensitive adhesive layer filling the air gap between the protective panel and the display body module, a pressure sensitive adhesive layer having a shear storage elastic modulus (G′) at 25° C. and 1 Hz of 1.0×10⁵ Pa or less and a gel fraction of 40% or more.

### PRIOR ART DOCUMENTS

### Patent Documents

[Patent Document 1] JP2010-97070A

### SUMMARY OF THE INVENTION

### Problems to be Solved by the Invention

If the storage elastic modulus at ordinary temperatures of the pressure sensitive adhesive layer is lowered as in Patent Document 1, however, the storage elastic modulus at high temperatures will be lowered more than necessary, and a problem may occur under durable conditions. For example, when subjected to high temperature and high humidity conditions, outgassing may occur from a plastic plate that is the protective panel, causing blisters such as air bubbles, floating, and delamination.

The present invention has been made in consideration of such actual circumstances, and an object of the present invention is to provide an adhesive sheet and a laminate that are excellent in the blister resistance.

### Means for Solving the Problems

To achieve the above object, first, the present invention provides an adhesive sheet comprising at least a pressure sensitive adhesive layer, wherein the adhesive sheet has an adhesive strength to soda-lime glass of larger than 1 N/25 mm and 100 N/25 mm or less, a pressure sensitive adhesive that constitutes the pressure sensitive adhesive layer is formed of a pressure sensitive adhesive composition that contains a (meth)acrylic ester polymer (A), and the (meth)acrylic ester polymer (A) contains, as a monomer unit that constitutes the polymer, an ethylene carbonate-containing monomer having an ethylene carbonate structure represented by Formula (1) below (Invention 1).

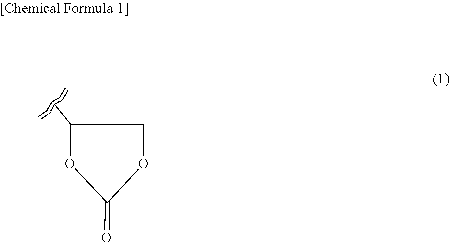

In the above invention (Invention 1), the ethylene carbonate structure is included in each side chain of the (meth)acrylic ester polymer (A) to strengthen the interaction between the side chains, and the glass-transition temperature (Tg) of the (meth)acrylic ester polymer (A) is relatively high. This allows the obtained pressure sensitive adhesive to have a strong cohesive strength and also allows the adhesive sheet to be excellent in the blister resistance. Moreover, the degree of polarization increases, and the dielectric constant of the obtained pressure sensitive adhesive also increases. Furthermore, from the viewpoint of polarity, the adhesive strength of the adhesive sheet, especially the adhesive strength to glass, is high.

In the above invention (Invention 1), the (meth)acrylic ester polymer (A) may preferably contain 0.5 mass % or more and 40 mass % or less of the ethylene carbonate-containing monomer as the monomer unit that constitutes the polymer (Invention 2).

Second, the present invention provides an adhesive sheet comprising at least a pressure sensitive adhesive layer, wherein the adhesive sheet has an adhesive strength to soda-lime glass of larger than 1 N/25 mm and 100 N/25 mm or less, the pressure sensitive adhesive layer is formed of a pressure sensitive adhesive composition that contains a (meth)acrylic ester polymer (A), and the (meth)acrylic ester polymer (A) contains, as a monomer unit that constitutes the polymer, a carbon dioxide-derived monomer obtained using carbon dioxide as a raw material (Invention 3).

According to the above invention (Invention 3), it is possible to consume carbon dioxide as a raw material in the production of the adhesive sheet, and this can contribute to the reduction of carbon dioxide, which is an internationally important issue, and accordingly to the Sustainable Development Goals (SDGs) adopted by the United Nations.

In the above invention (Invention 3), 0.1 mol or more of carbon dioxide may be preferably consumed for 1 mol of the carbon dioxide-derived monomer when producing the carbon dioxide-derived monomer (Invention 4).

In the above invention (Invention 3, 4), the carbon dioxide-derived monomer may be preferably obtained by reacting an epoxy group-containing compound and carbon dioxide (Invention 5).

In the above invention (Invention 1 to 5), a pressure sensitive adhesive that constitutes the pressure sensitive adhesive layer may preferably have a storage elastic modulus (G′) at 25° C. of 0.01 MPa or more and 2.0 MPa or less (Invention 6).

In the above invention (Invention 1 to 6), a pressure sensitive adhesive that constitutes the pressure sensitive adhesive layer may preferably have a loss tangent (tan δ) at 25° C. of 0.3 or more and 3.0 or less, wherein the loss tangent (tan δ) at 25° C. is obtained from dynamic viscoelasticity measurement in accordance with JIS K7244-1 (Invention 7).

In the above invention (Invention 1 to 7), a pressure sensitive adhesive that constitutes the pressure sensitive adhesive layer may preferably have a dielectric constant εₛ at 40 kHz of 5.80 or more and 10 or less (Invention 8).

In the above invention (Invention 1 to 8), the adhesive sheet may preferably comprise two release sheets, and the pressure sensitive adhesive layer may be preferably interposed between the two release sheets so as to be in contact with release surfaces of the two release sheets (Invention 9).

Third, the present invention provides a laminate comprising: two display body structural members; and a pressure sensitive adhesive layer interposed between the two display body structural members, wherein the pressure sensitive adhesive layer is formed of the pressure sensitive adhesive layer of the adhesive sheet (Invention 1 to 9) (Invention 10).

In the above invention (Invention 10), at least one of the display body structural members may preferably include a plastic plate (Invention 11).

### Advantageous Effect of the Invention

The adhesive sheet and laminate according to the present invention are excellent in the blister resistance.

### BRIEF DESCRIPTION OF DRAWINGS

FIG. 1 is a cross-sectional view of an adhesive sheet according to an embodiment of the present invention.

FIG. 2 is a cross-sectional view of a laminate according to an embodiment of the present invention.

### EMBODIMENTS FOR CARRYING OUT THE INVENTION

Hereinafter, one or more embodiments of the present invention will be described.

### <Pressure Sensitive Adhesive Sheet According to First Embodiment>

The adhesive sheet according to the first embodiment includes at least a pressure sensitive adhesive layer and may be preferably an adhesive sheet in which a release sheet is laminated on one surface of the pressure sensitive adhesive layer or release sheets are laminated on both surfaces of the pressure sensitive adhesive layer.

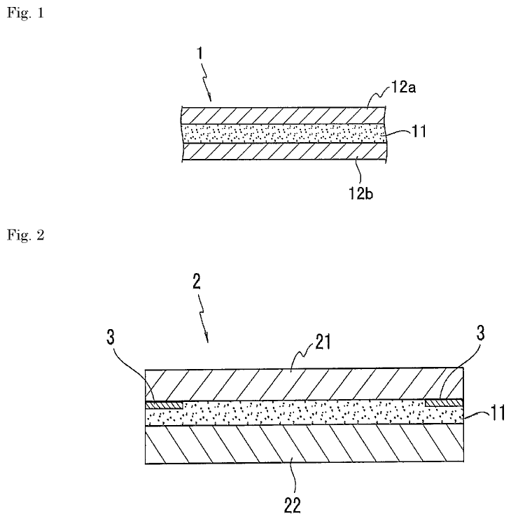

FIG. 1 illustrates a specific configuration as an example of the adhesive sheet according to the first embodiment.

As illustrated in FIG. 1, an adhesive sheet 1 according to an embodiment is composed of two release sheets 12a and 12b and a pressure sensitive adhesive layer 11 interposed between the two release sheets 12a and 12b so as to be in contact with release surfaces of the two release sheets 12a and 12b. The release surface of a release sheet in the present specification refers to a surface having releasability in the release sheet, and examples of the release surface include both a surface subjected to release treatment and a surface that exhibits releasability even without being subjected to release treatment.

### 1. Each Member

### 1-1. Pressure Sensitive Adhesive Layer

A pressure sensitive adhesive that constitutes the pressure sensitive adhesive layer 11 of the adhesive sheet 1 according to the present embodiment is formed of a pressure sensitive adhesive composition that contains a (meth)acrylic ester polymer (A) and may preferably contain a crosslinker (B) (this composition may be referred to as a “pressure sensitive adhesive composition P,” hereinafter). As used in the present specification, the term “(meth)acrylic acid” refers to both the acrylic acid and the methacrylic acid. The same applies to other similar terms. As used in the present specification, the term “polymer” encompasses the concept of a “copolymer.”

### (1) Components of Pressure Sensitive Adhesive Composition

### (1-1) (Meth)Acrylic Ester Polymer (A)

The (meth)acrylic ester polymer (A) contains, as a monomer unit that constitutes the polymer, an ethylene carbonate-containing monomer having an ethylene carbonate structure represented by the following Formula (1).

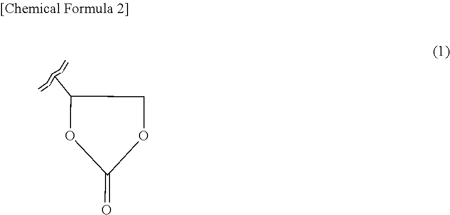

The ethylene carbonate-containing monomer is not particularly limited, provided that it includes the ethylene carbonate structure and can perform a polymerization reaction with other monomers that constitute the (meth)acrylic ester polymer (A).

The (meth)acrylic ester polymer (A) is composed of the ethylene carbonate-containing monomer, and the pressure sensitive adhesive composition P according to the present embodiment thereby includes the ethylene carbonate structure as a side chain of the (meth)acrylic ester polymer (A). When the ethylene carbonate structure is included as a side chain of the (meth)acrylic ester polymer (A), the interaction between side chains is strengthened, and the glass-transition temperature (Tg) of the (meth)acrylic ester polymer (A) is relatively high. This allows the obtained pressure sensitive adhesive to have a strong cohesive strength and also allows the adhesive sheet 1 to be excellent in the blister resistance. Moreover, the degree of polarization increases, and the dielectric constant of the obtained pressure sensitive adhesive also increases. Furthermore, from the viewpoint of polarity, the adhesive strength of the adhesive sheet 1, especially the adhesive strength to glass, is high.

Preferred examples of the ethylene carbonate-containing monomer include (meth)acrylic esters having a structure in which an organic group having an ethylene carbonate structure and a (meth)acryloyloxy group are bonded. Examples of such (meth)acrylic esters include an acrylic ester represented by the following Formula (2)

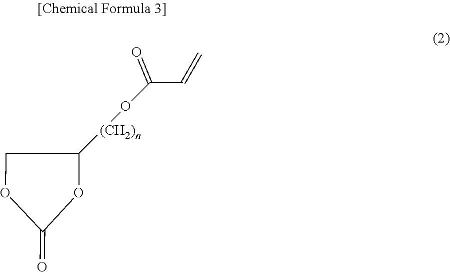

and a methacrylic ester represented by the following Formula (3).

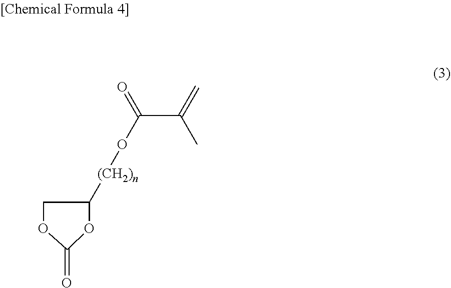

In both Formulae (2) and (3), n represents an integer of 0 or more. Among the (meth)acrylic esters represented by the above Formulae (2) and (3), a (meth)acrylic ester in which n is 1 or more may be preferred, and a (meth)acrylic ester in which n is 2 or more may also be preferred. When n is 1 or more, the ethylene carbonate group as a side chain of the (meth)acrylic ester polymer (A) is present at a position relatively distant from the main chain, and the probability that the ethylene carbonate structures present in the obtained pressure sensitive adhesive overlap each other increases. With this configuration, the stacking interaction between the ethylene carbonate structures works, and the mechanical properties (viscoelasticity, tensile physical properties) and adhesive strength to be described later may be easily and suitably developed, thus providing more excellent blister resistance. The upper limit of the above n is not particularly limited, but from the viewpoint of polymerizability, it may be preferably 10 or less, more preferably 6 or less, particularly preferably 4 or less, and further preferably 3 or less. Among these, (meth)acrylic esters with n=2 may be preferred, and (2-oxo-1,3-dioxolan-4-yl)methyl methacrylate with n=2 in Formula (3) may be particularly preferred. One type of the ethylene carbonate-containing monomer may be used alone or two or more types may also be used in combination.

The (meth)acrylic ester polymer (A) may preferably contain 0.5 mass % or more, more preferably 1 mass % or more, particularly preferably 3 mass % or more, and further preferably 5 mass % or more of the above ethylene carbonate-containing monomer as a monomer unit that constitutes the polymer. This can enhance the stacking interaction effect due to the ethylene carbonate groups in the pressure sensitive adhesive to improve the cohesive strength of the obtained pressure sensitive adhesive, so that the mechanical properties (viscoelasticity, tensile physical properties) and adhesive strength to be described later may be easily and suitably developed, and the adhesive sheet 1 is more excellent in the blister resistance. Moreover, the degree of polarization further increases, and the dielectric constant is further improved. Furthermore, also from the viewpoint of polarity, the adhesive strength of the adhesive sheet 1, especially the adhesive strength to glass, becomes higher.

From another aspect, the (meth)acrylic ester polymer (A) may preferably contain 40 mass % or less, more preferably 30 mass % or less, particularly preferably 25 mass % or less, and further preferably 20 mass % or less of the above ethylene carbonate-containing monomer as a monomer unit that constitutes the polymer. This allows the viscoelasticity, tensile physical properties, and adhesive strength of the adhesive sheet 1 to be easily adjusted within the ranges, which will be described later.

The (meth)acrylic ester polymer (A) in the present embodiment may preferably contain (meth)acrylic alkyl ester as a monomer unit that constitutes the polymer. This allows the obtained pressure sensitive adhesive to develop good pressure sensitive adhesive properties. The alkyl group may be linear or branched.

From the viewpoint of pressure sensitive adhesive properties, (meth)acrylic alkyl ester whose carbon number of alkyl group is 1 to 20 may be preferred as the (meth)acrylic alkyl ester. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate.

Among the above, (meth)acrylic alkyl ester whose carbon number of alkyl group is 2 to 12 may be more preferred and (meth)acrylic alkyl ester whose carbon number of alkyl group is 4 to 10 may be particularly preferred from the viewpoint of giving good pressure sensitive adhesive properties. Specifically, n-butyl (meth)acrylate and 2-ethylhexyl (meth)acrylate may be preferred, and n-butyl acrylate and 2-ethylhexyl acrylate may be particularly preferred. These may each be used alone or two or more types may also be used in combination.

From the viewpoint of giving good pressure sensitive adhesive properties, the (meth)acrylic ester polymer (A) may preferably contain 40 mass % or more, more preferably 50 mass % or more, particularly preferably 55 mass % or more, and further preferably 60 mass % or more of the (meth)acrylic alkyl ester as a monomer unit that constitutes the polymer. Additionally or alternatively, from the viewpoint of ensuring the content of other monomers, the (meth)acrylic ester polymer (A) may preferably contain 99.5 mass % or less, more preferably 99 mass % or less, particularly preferably 98 mass % or less, and further preferably 94 mass % or less of the (meth)acrylic alkyl ester.

The (meth)acrylic ester polymer (A) may also preferably contain, as a monomer that constitutes the polymer, a reactive functional group-containing monomer having a reactive functional group in the molecule. When containing a reactive functional group-containing monomer, the (meth)acrylic ester polymer (A) reacts with the crosslinker (B), which will be described late, via the reactive functional group derived from the reactive functional group-containing monomer, thereby forming a three-dimensional network structure as the crosslinked structure. This allows the obtained pressure sensitive adhesive to have enhanced cohesive strength and easily and suitably develop the mechanical properties (viscoelasticity, tensile physical properties) and adhesive strength to be described later, thus providing more excellent blister resistance.

Preferred examples of the above reactive functional group-containing monomer include a monomer having a hydroxyl group in the molecule (hydroxyl group-containing monomer), a monomer having a carboxy group in the molecule (carboxy group-containing monomer), and a monomer having an amino group in the molecule (amino group-containing monomer). Among these, the hydroxyl group-containing monomer may be preferred from the viewpoint of excellent reactivity with the crosslinker (B). These reactive functional group-containing monomers may each be used alone or two or more types may also be used in combination.

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among these, 2-hydroxyethyl (meth)acrylate and 4-hydroxybutyl (meth)acrylate may be preferred and 2-hydroxyethyl acrylate and 4-hydroxybutyl acrylate may be particularly preferred from the viewpoints of the reactivity with the crosslinker (B) and the polymerizability with other monomers. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. These may each be used alone or two or more types may also be used in combination.

Examples of the amino group-containing monomer include aminoethyl (meth)acrylate and n-butylaminoethyl (meth)acrylate. These may each be used alone or two or more types may also be used in combination.

The (meth)acrylic ester polymer (A) may preferably contain, as the lower limit, 0.1 mass % or more, more preferably 0.5 mass % or more, and particularly preferably 1.0 mass % or more of the reactive functional group-containing monomer as a monomer unit that constitutes the polymer. This allows the obtained pressure sensitive adhesive to be formed with a good crosslinked structure and easily and suitably develop the mechanical properties (viscoelasticity, tensile physical properties) and adhesive strength to be described later, thus providing more excellent blister resistance. In particular, from the viewpoint of improving the adhesive strength, the (meth)acrylic ester polymer (A) may preferably contain 5 mass % or more, particularly preferably 10 mass % or more, and further preferably 15 mass % or more of the reactive functional group-containing monomer as a monomer unit that constitutes the polymer.

From another aspect, the (meth)acrylic ester polymer (A) may preferably contain, as the upper limit, 40 mass % or less, more preferably 30 mass % or less, particularly preferably 25 mass % or less, and further preferably 20 mass % or less of the reactive functional group-containing monomer as a monomer unit that constitutes the polymer. When the (meth)acrylic ester polymer (A) contains the reactive functional group-containing monomer within the above range as a monomer unit that constitutes the polymer, the obtained pressure sensitive adhesive can be formed with a good crosslinked structure and can easily and suitably develop the mechanical properties (viscoelasticity, tensile physical properties) and adhesive strength to be described later, thus providing more excellent blister resistance.

The (meth)acrylic ester polymer (A) in the present embodiment may further contain other monomers as monomers that constitute the polymer. Examples of the other monomers include alicyclic structure-containing (meth)acrylic esters such as dicyclopentanyl (meth)acrylate, adamantyl (meth)acrylate, isobornyl (meth)acrylate, dicyclopentenyl (meth)acrylate, and dicyclopentenyl oxyethyl (meth)acrylate; (meth)acrylic alkoxyalkyl esters such as methoxyethyl (meth)acrylate and ethoxyethyl (meth)acrylate; non-crosslinkable acrylamides such as acrylamide and methacrylamide; (meth)acrylic esters having non-crosslinkable tertiary amino groups, such as N,N-dimethylaminoethyl (meth)acrylate and N,N-dimethylaminopropyl (meth)acrylate; vinyl acetate; and styrene. These may each be used alone or two or more types may also be used in combination.

The polymerization form of the (meth)acrylic ester polymer (A) in the present embodiment may be a random polymer or may also be a block polymer. The (meth)acrylic ester polymer (A) can be obtained by polymerizing any of the above-described monomers using an ordinary method. For example, the (meth)acrylic ester polymer (A) can be prepared by polymerization, such as using an emulsion polymerization method, a solution polymerization method, a suspension polymerization method, a bulk polymerization method, or an aqueous solution polymerization method. Among these, the solution polymerization method performed in an organic solvent may be preferably adopted for preparing the (meth)acrylic ester polymer (A) from the viewpoint of stability during polymerization and ease of handling during use.

The weight-average molecular weight of the (meth)acrylic ester polymer (A) may be preferably 200,000 or more, more preferably 400,000 or more, particularly preferably 500,000 or more, and further preferably 600,000 or more. From another aspect, the weight-average molecular weight of the (meth)acrylic ester polymer (A) may be preferably 2,000,000 or less, more preferably 1,500,000 or less, particularly preferably 1,000,000 or less, and further preferably 800,000 or less. When the weight-average molecular weight of the (meth)acrylic ester polymer (A) falls within the above range, the obtained pressure sensitive adhesive can easily and suitably develop the mechanical properties (viscoelasticity and/or tensile physical properties) and adhesive strength to be described later, and the adhesive sheet 1 is more excellent in the blister resistance. As used in the present specification, the weight-average molecular weight refers to a standard polystyrene equivalent value that is measured using a gel permeation chromatography (GPC) method.

The pressure sensitive adhesive composition P according to the present embodiment may contain one type or two or more types of the above-described (meth)acrylic ester polymer (A). Additionally or alternatively, the pressure sensitive adhesive composition P according to the present embodiment may contain another (meth)acrylic ester polymer together with the above-described (meth)acrylic ester polymer (A).

### (1-2) Crosslinker (B)

The pressure sensitive adhesive composition P in the present embodiment may preferably contain a crosslinker (B). When the previously described (meth)acrylic ester polymer (A) contains the above-described reactive functional group-containing monomer as a monomer that constitutes the polymer, the crosslinker (B) reacts with the reactive functional group of the reactive functional group-containing monomer to form a three-dimensional network structure. This allows the obtained pressure sensitive adhesive to have improved cohesive strength and easily and suitably develop the mechanical properties (viscoelasticity and/or tensile physical properties) and adhesive strength to be described later, thus providing more excellent blister resistance.

It suffices that the crosslinker (B) is reactive with a reactive functional group of the (meth)acrylic ester polymer (A). Examples of the crosslinker (B) include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker. One type of the crosslinker (B) may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, trimethylolpropane-modified aromatic polyisocyanate may be preferred and trimethylolpropane-modified xylylene diisocyanate may be particularly preferred from the viewpoint of reactivity with a reactive functional group of the (meth)acrylic ester polymer (A).

The content of the crosslinker (B) in the pressure sensitive adhesive composition P may be preferably 0.01 mass parts or more, more preferably 0.05 mass parts or more, particularly preferably 0.1 mass parts or more, and further preferably 0.15 mass parts or more with respect to 100 mass parts of the (meth)acrylic ester polymer (A). From another aspect, the content of the crosslinker (B) may be preferably 10 mass parts or less, more preferably 5 mass parts or less, particularly preferably 1 mass part or less, and further preferably 0.5 mass parts or less with respect to 100 mass parts of the (meth)acrylic ester polymer (A). When the content of the crosslinker (B) falls within the above range, the degree of crosslinking is appropriate, the mechanical properties (viscoelasticity and/or tensile physical properties) and adhesive strength to be described later can be easily and suitably developed, and the blister resistance of the adhesive sheet 1 is more excellent.

### (1-3) Various Additives

If desired, the pressure sensitive adhesive composition P can contain one or more of various additives, such as an antistatic, a silane coupling agent, an anticorrosive, an ultraviolet absorber, a tackifier, an antioxidant, a light stabilizer, a softening agent, and a refractive index adjuster, which are commonly used in an acrylic-based pressure sensitive adhesive. The additives which constitute the pressure sensitive adhesive composition P are deemed not to include a polymerization solvent or a diluent solvent, which will be described later.

When the pressure sensitive adhesive composition P contains an antistatic, it is possible, in the obtained pressure sensitive adhesive sheet 1, to suppress adhesion of dust due to an electrostatic action and adverse electrical effects on an adherend.

Examples of the antistatic include ionic compounds and nonionic compounds, among which ionic compounds may be preferred. The ionic compound may be liquid (ionic liquid) or solid (ionic solid) at room temperature. Here, the ionic compound in the present specification refers to a compound in which a cation and an anion are bound together mainly by electrostatic attraction. One type of the antistatic may be used alone or two or more types may also be used in combination.

As the ionic compound, a nitrogen-containing onium salt, a sulfur-containing onium salt, a phosphorus-containing onium salt, an alkali metal salt, or an alkaline-earth metal salt may be preferred, and an alkali metal salt may be particularly preferred from the viewpoint of improving the adhesive strength.

Specific examples of the alkali metal salt include potassium bis(fluorosulfonyl)imide, lithium bis(fluorosulfonyl)imide, potassium bis(fluoromethanesulfonyl)imide, lithium bis(fluoromethanesulfonyl)imide, potassium bis(trifluoromethanesulfonyl)imide, and lithium bis(trifluoromethanesulfonyl)imide. Among these, lithium bis(trifluoromethanesulfonyl)imide may be preferred from the viewpoint of improving the adhesive strength.

When the pressure sensitive adhesive composition P contains an antistatic, the content of the antistatic may be preferably 0.01 mass % or more, more preferably 0.05 mass % or more, particularly preferably 0.1 mass % or more, and further preferably 0.3 mass % or more. From another aspect, the content may be preferably 10 mass % or less, preferably 5 mass % or less, particularly preferably 1 mass % or less, and further preferably 0.6 mass % or less. When the antistatic is contained within the above range, the surface resistivity, which will be described later, can be easily adjusted within a desired range.

When the pressure sensitive adhesive composition P contains a silane coupling agent, the obtained pressure sensitive adhesive has improved interfacial adhesion to a glass member or a plastic plate. This allows the adhesive sheet 1 to be more excellent in the blister resistance.

The silane coupling agent may be preferably an organosilicon compound having at least one alkoxysilyl group in the molecule, which has satisfactory compatibility with the (meth)acrylic ester polymer (A) and light transmittance.

Examples of such a silane coupling agent include polymerizable unsaturated group-containing silicon compounds such as vinyltrimethoxysilane, vinyltriethoxysilane and methacryloxypropyltrimethoxysilane, silicon compounds having an epoxy structure, such as 3-glycidoxypropyltrimethoxysilane and 2-(3,4-epoxycyclohexyl)ethyltrimethoxysilane, mercapto group-containing silicon compounds such as 3-mercaptopropyltrimethoxysilane, 3-mercaptopropyltriethoxysilane and 3-mercaptopropyldimethoxymethylsilane, amino group-containing silicon compounds such as 3-aminopropyltrimethoxysilane, N-(2-aminoethyl)-3-aminopropyltrimethoxysilane and N-(2-aminoethyl)-3-aminopropylmethyldimethoxysilane, 3-chloropropyltrimethoxysilane, 3-isocyanatepropyltriethoxysilane, and condensates of at least one of these and an alkyl group-containing silicon compound such as methyltriethoxysilane, ethyltriethoxysilane, methyltrimethoxysilane and ethyltrimethoxysilane. These may each be used alone or two or more types may also be used in combination.

When the pressure sensitive adhesive composition P contains a silane coupling agent, the content of the silane coupling agent may be preferably 0.01 mass parts or more, particularly preferably 0.05 mass parts or more, and further preferably 0.1 mass parts or more with respect to 100 mass parts of the (meth)acrylic ester polymer (A). From another aspect, the content may be preferably 2 mass parts or less, particularly preferably 1 mass part or less, and further preferably 0.5 mass parts or less. When the content of the silane coupling agent falls within the above range, the obtained pressure sensitive adhesive develops good interfacial adhesion to an adherend, and the adhesive sheet 1 is more excellent in the blister resistance.

### (2) Preparation of Pressure Sensitive Adhesive Composition

The pressure sensitive adhesive composition P can be prepared through preparing the (meth)acrylic ester polymer (A) and, if desired, adding the crosslinker (B), a diluting solvent, additives, etc. to the (meth)acrylic ester polymer (A).

The (meth)acrylic ester polymer (A) can be prepared by polymerizing a mixture of the monomers which constitute the polymer using a commonly-used radical polymerization method. Polymerization of the (meth)acrylic ester polymer (A) may be preferably carried out by a solution polymerization method, if desired, using a polymerization initiator. However, the present invention is not limited to this, and polymerization may be carried out without a solvent. Examples of the polymerization solvent include ethyl acetate, n-butyl acetate, isobutyl acetate, toluene, acetone, hexane, and methyl ethyl ketone and two or more types thereof may also be used in combination.

Examples of the polymerization initiator include azo-based compounds and organic peroxides and two or more types thereof may also be used in combination. Examples of the azo-based compounds include 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxides include benzoyl peroxide, t-butyl perbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxybivalate, (3,5,5-trimethylhexanoyl)peroxide, dipropionyl peroxide, and diacetyl peroxide.

In the above polymerization step, the weight-average molecular weight of the polymer to be obtained can be adjusted by compounding a chain transfer agent such as 2-mercaptoethanol.

After the (meth)acrylic ester polymer (A) is obtained, the pressure sensitive adhesive composition P (coating solution) diluted with a solvent may be obtained through adding the crosslinker (B), a diluting solvent, additives, etc. to the solution of the (meth)acrylic ester polymer (A), if desired, and sufficiently mixing them. If any of the above components is in the form of a solid, or if precipitation occurs when the component is mixed with another component in an undiluted state, the component may be preliminarily dissolved in or diluted with a diluting solvent alone and then mixed with the other component.

Examples of the diluting solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity is within any range in which the coating is possible. For example, the pressure sensitive adhesive composition P may be diluted to a concentration of 10 to 60 mass %. When obtaining the coating solution, the addition of a diluting solvent or the like is not a necessary condition, and the diluting solvent may not be added if the pressure sensitive adhesive composition P has a viscosity or the like that enables the coating. In this case, the pressure sensitive adhesive composition P may be a coating solution in which the polymerization solvent itself for the (meth)acrylic ester polymer (A) is used as a diluting solvent.

### (3) Formation of Pressure Sensitive Adhesive Layer

The pressure sensitive adhesive layer 11 in the present embodiment may be preferably made of a pressure sensitive adhesive obtained by crosslinking the pressure sensitive adhesive composition P (a coating layer of the pressure sensitive adhesive composition P). Crosslinking of the pressure sensitive adhesive composition P can be usually performed by heat treatment. Drying treatment when volatilizing a diluent solvent and the like from the coating layer of the pressure sensitive adhesive composition P applied to a desired object can also serve as the above heat treatment.

The heating temperature of the heat treatment may be preferably 50° C. to 150° C. and particularly preferably 70° C. to 120° C. The heating time may be preferably 10 seconds to 10 minutes and particularly preferably 50 seconds to 2 minutes.

After the heat treatment, if necessary, an aging period at an ordinary temperature (e.g., 23° C., 50% RH) for about 1 to 2 weeks may be provided. When the aging period is necessary, the pressure sensitive adhesive is formed after the aging period passes, while when the aging period is not necessary, the pressure sensitive adhesive is formed after the heat treatment.

The above heat treatment (and aging) allows the (meth)acrylic ester polymer (A) to be sufficiently crosslinked via the crosslinker (B). The pressure sensitive adhesive thus obtained can easily and suitably develop the mechanical properties (viscoelasticity and/or tensile physical properties) and adhesive strength to be described below and is excellent in the blister resistance.

### (4) Physical Properties of Pressure Sensitive Adhesive

### (4-1) Gel Fraction

The gel fraction of the pressure sensitive adhesive in the present embodiment may be preferably 30% or more, more preferably 40% or more, particularly preferably 50% or more, and further preferably 54% or more as the lower limit.

When the lower limit of the above gel fraction is as the above, the pressure sensitive adhesive has high cohesive strength and can easily and suitably develop the mechanical properties (viscoelasticity and/or tensile physical properties) and adhesive strength to be described below, and the adhesive sheet 1 is more excellent in the blister resistance.

From another aspect, the above gel fraction may be preferably 90% or less, more preferably 80% or less, particularly preferably 75% or less, and further preferably 72% or less as the upper limit. When the upper limit of the above gel fraction is as the above, the obtained pressure sensitive adhesive has a suitable degree of crosslinking and develops good adhesive strength without becoming unduly hard, thus being excellent in the adhesion properties to an adherend. Here, the measurement method for the gel fraction of the pressure sensitive adhesive is as described in the Testing Example, which will be described later.

### (4-2) Storage Elastic Modulus (G′)

The storage elastic modulus (G′) at 25° C. of the pressure sensitive adhesive in the present embodiment may be preferably 0.01 MPa or more, more preferably 0.02 MPa or more, particularly preferably 0.04 MPa or more, and further preferably 0.06 MPa or more as the lower limit. When the lower limit of the above storage elastic modulus (G′) is as the above, the adhesive sheet 1 is more excellent in the blister resistance. Moreover, the adhesive strength easily satisfies the value to be described later. The testing method for the storage elastic modulus (G′) is as described in the Testing Example, which will be described later.

From another aspect, the storage elastic modulus (G′) at 25° C. of the pressure sensitive adhesive in the present embodiment may be preferably 2 MPa or less, more preferably 1 MPa or less, particularly preferably 0.5 MPa or less, and further preferably 0.3 MPa or less as the upper limit. When the upper limit of the above storage elastic modulus (G′) is as the above, the adhesive strength easily satisfies the value to be described later.

The storage elastic modulus (G′) at 85° C. of the pressure sensitive adhesive in the present embodiment may be preferably 0.001 MPa or more, more preferably 0.005 MPa or more, particularly preferably 0.010 MPa or more, and further preferably 0.015 MPa or more as the lower limit. When the lower limit of the above storage elastic modulus (G′) is as the above, the adhesive sheet 1 is more excellent in the blister resistance.

From another aspect, the storage elastic modulus (G′) at 85° C. of the pressure sensitive adhesive in the present embodiment may be preferably 1 MPa or less, more preferably 0.5 MPa or less, particularly preferably 0.1 MPa or less, and further preferably 0.05 MPa or less as the upper limit. When the upper limit of the above storage elastic modulus (G′) is as the above, the adhesive sheet 1 is more excellent in the blister resistance.

### (4-3) Loss Tangent (tan δ)

The loss tangent (tan δ) at 25° C. of the pressure sensitive adhesive in the present embodiment may be preferably 0.3 or more, particularly preferably 0.34 or more, and further preferably 0.38 or more as the lower limit. When the lower limit of the above loss tangent (tan δ) is as the above, the obtained pressure sensitive adhesive exhibits appropriate flexibility and has suitable interfacial adhesion to an adherend, and the adhesive sheet 1 is more excellent in the blister resistance. Moreover, the adhesive strength easily satisfies the value to be described later. The testing method for the loss tangent is as described in the Testing Example, which will be described later.

From another aspect, the loss tangent (tan δ) at 25° C. of the pressure sensitive adhesive in the present embodiment may be preferably 3 or less, more preferably 2 or less, particularly preferably 1.5 or less, and further preferably 1.2 or less as the upper limit. When the upper limit of the above loss tangent (tan δ) is as the above, the obtained pressure sensitive adhesive develops appropriate rigidity without becoming unduly soft, and the adhesive sheet 1 is more excellent in the blister resistance. Moreover, the adhesive strength easily satisfies the value to be described later.

The loss tangent (tan δ) at 85° C. of the pressure sensitive adhesive in the present embodiment may be preferably 0.3 or more, more preferably 0.34 or more, particularly preferably 0.38 or more, and further preferably 0.42 or more as the lower limit. When the lower limit of the above loss tangent (tan δ) is as the above, the obtained pressure sensitive adhesive exhibits appropriate flexibility at high temperatures and has suitable interfacial adhesion to an adherend, and the adhesive sheet 1 is more excellent in the blister resistance.

From another aspect, the loss tangent (tan δ) at 85° C. of the pressure sensitive adhesive in the present embodiment may be preferably 3 or less, more preferably 2 or less, particularly preferably 1.2 or less, and further preferably 0.8 or less as the upper limit. When the upper limit of the above loss tangent (tan δ) is as the above, the obtained pressure sensitive adhesive develops appropriate rigidity without becoming unduly soft at high temperatures, and the adhesive sheet 1 is more excellent in the blister resistance.

### (4-4) Dielectric Constant

The dielectric constant εₛ at 40 kHz of the pressure sensitive adhesive in the present embodiment may be preferably 5.8 or more, more preferably 6.0 or more, particularly preferably 6.3 or more, further preferably 6.6 or more, and most preferably 6.7 or more as the lower limit. When the lower limit of the above dielectric constant εₛ is as the above, it is possible to increase the sensitivity at the time of inputting in the case in which the pressure sensitive adhesive is applied to a member requiring a high dielectric constant, for example, a structural member such as a touch panel.

On the other hand, the above dielectric constant εₛ may be preferably 10 or less, more preferably 9 or less, particularly preferably 8 or less, and further preferably 7 or less as the upper limit. When the upper limit of the above dielectric constant εₛ is as the above, it is possible to suppress noise generation at the time of inputting, for example, in the case in which the pressure sensitive adhesive is applied to a structural member such as a touch panel. The measurement method for the dielectric constant εₛ of the pressure sensitive adhesive is as described in the Testing Example, which will be described later.

### (5) Thickness of Pressure Sensitive Adhesive Layer

The thickness (value measured in accordance with JIS K7130) of the pressure sensitive adhesive layer 11 in the present embodiment may be preferably 1 μm or more, more preferably 5 μm or more, particularly preferably 10 μm or more, and further preferably 20 μm or more. This allows the pressure sensitive adhesive layer 11 to easily exhibit the adhesive strength, which will be described later, and to have more excellent blister resistance. From another aspect, the thickness of the pressure sensitive adhesive layer 11 may be preferably 100 μm or less, more preferably 75 μm or less, particularly preferably 50 μm or less, and further preferably 30 μm or less. This can suppress defects in the appearance such as indentations and dents on the pressure sensitive adhesive layer 11. Moreover, even with a relatively thin thickness, it is easy to develop the desired adhesive strength, and the blister resistance is excellent. This can contribute to reduction in the thickness and weight of a display device such as a touch panel. The pressure sensitive adhesive layer 11 may be formed as a single layer or may also be formed by laminating a plurality of layers.

### 1-2. Release Sheets

The release sheets 12a and 12b are to protect the pressure sensitive adhesive layer 11 until the use of the adhesive sheet 1 and are removed when using the adhesive sheet 1 (pressure sensitive adhesive layer 11). In the adhesive sheet 1 according to the present embodiment, one or both of the release sheets 12a and 12b may be unnecessary.

Examples of the release sheets 12a and 12b for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene-(meth)acrylic acid polymer films, ethylene-(meth)acrylic ester polymer films, polystyrene films, polycarbonate films, polyimide films, and fluorine resin films. Crosslinked films thereof may also be used. Laminate films each obtained by laminating a plurality of such films may also be used.

It may be preferred to perform release treatment for the release surfaces of the above release sheets 12a and 12b. Examples of a release agent to be used for the release treatment include alkyd-based, silicone-based, fluorine-based, unsaturated polyester-based, polyolefin-based, and wax-based release agents.

The thickness of the release sheets 12a and 12b is not particularly limited, but may be usually about 20 to 150 μm.

### 2. Physical Properties of Pressure Sensitive Adhesive Sheet

### (1) Tensile Physical Properties (Breaking Elongation/Film Strength/Breaking Energy)

The breaking elongation of the pressure sensitive adhesive layer 11 measured by a tensile test in the present embodiment may be preferably 200% or more, more preferably 400% or more, particularly preferably 500% or more, and further preferably 580% or more as the lower limit. When the lower limit of the breaking elongation of the pressure sensitive adhesive layer 11 is as the above, the flexibility is relatively high, and even if some irregularities are present on an adherend, the followability (interfacial adhesion) to the adherend is excellent, and good blister resistance can be obtained.

On the other hand, the upper limit of the above breaking elongation may be preferably 3000% or less, more preferably 2000% or less, and particularly preferably 1600% or less. From the viewpoints of improving the adhesion strength to glass and the blister resistance, the upper limit may be further preferably 1400% or less.

Specifically, the above tensile test is performed through forming only the pressure sensitive adhesive layer to a thickness of 500 μm, a width of 10 mm, and a length of 75 mm in the elongating direction (of which the length of the measurement site is 20 mm) and elongating the pressure sensitive adhesive layer at a speed of 200 mm/min under an environment of 23° C. and 50% RH.

Additionally or alternatively, the film strength of the pressure sensitive adhesive layer 11 measured by the tensile test may be preferably 0.45 N/mm² or more, more preferably 0.50 N/mm² or more, particularly preferably 0.60 N/mm² or more, and further preferably 0.65 N/mm² or more. This allows the obtained pressure sensitive adhesive to exhibit suitable cohesive strength, and the blister resistance is more excellent. From another aspect, the above film strength may be preferably 10 N/mm² or less, more preferably 8 N/mm² or less, particularly preferably 6 N/mm² or less, further preferably 4 N/mm² or less, and most preferably 2.5 N/mm² or less. This can improve the followability (interfacial adhesion) to an adherend even if some irregularities are present on the adherend. The film strength is calculated by dividing the stress at break in the above tensile test by the cross-sectional area (thickness×width) of the pressure sensitive adhesive layer.

Additionally or alternatively, the breaking energy of the pressure sensitive adhesive layer 11 measured by the tensile test may be preferably 240 J or more, more preferably 260 J or more, particularly preferably 300 J or more, and further preferably 340 J or more. This allows the obtained pressure sensitive adhesive to be prevented from cohesive failure and to exhibit good cohesive strength and adhesive strength, and the blister resistance is particularly good. The upper limit of the above breaking energy is not particularly limited, but may be 3000 J or less in an embodiment, 2000 J or less in another embodiment, 1500 J or less in still another embodiment, or 1000 J or less in a further embodiment. The breaking energy is calculated by integrating the stress-strain curve obtained by the above tensile test from the initial point to the breaking point.

### (2) Adhesive Strength

The adhesive strength of the adhesive sheet 1 according to the present embodiment to soda-lime glass may be preferably more than 1 N/25 mm, more preferably 6 N/25 mm or more, particularly preferably 11 N/25 mm or more, and further preferably 14 N/25 mm or more as the lower limit. This allows the blister resistance to be more excellent. On the other hand, the upper limit of the above adhesive strength to soda-lime glass is not particularly limited, but considering the case in which reworkability may be required, the upper limit may be preferably 100 N/25 mm or less, more preferably 60 N/25 mm or less, particularly preferably 30 N/25 mm or less, and further preferably 22 N/25 mm or less.

The adhesive strength of the adhesive sheet 1 according to the present embodiment to non-alkali glass may be preferably 1 N/25 mm or more, more preferably 6 N/25 mm or more, particularly preferably 11 N/25 mm or more, and further preferably 15 N/25 mm or more as the lower limit. This allows the blister resistance to be more excellent. On the other hand, the upper limit of the above adhesive strength to non-alkali glass is not particularly limited, but considering the case in which reworkability may be required, the upper limit may be preferably 100 N/25 mm or less, more preferably 60 N/25 mm or less, particularly preferably 30 N/25 mm or less, and further preferably 20 N/25 mm or less.

In the adhesive sheet 1 according to the present embodiment, the (meth)acrylic ester polymer (A) contains the previously described ethylene carbonate-containing monomer as a monomer unit that constitutes the polymer, and the adhesive strength to glass can thereby be increased by about 1.2 to 2 times as compared with that of an adhesive sheet using another (meth)acrylic ester polymer (A) having a similar monomer configuration. The adhesive sheet 1 according to the present embodiment therefore exhibits particularly excellent adhesive strength when glass is used as an adherend.

The adhesive strength of the adhesive sheet 1 according to the present embodiment to polycarbonate may be preferably 1 N/25 mm or more, more preferably 4 N/25 mm or more, particularly preferably 8 N/25 mm or more, and further preferably 12 N/25 mm or more as the lower limit. This allows the blister resistance to be more excellent. On the other hand, the upper limit of the above adhesive strength to polycarbonate is not particularly limited, but considering the case in which reworkability may be required, the upper limit may be preferably 100 N/25 mm or less, more preferably 60 N/25 mm or less, and particularly preferably 30 N/25 mm or less. From the viewpoint that the blister resistance is improved together with the cohesive strength of the obtained pressure sensitive adhesive, the upper limit may be preferably 22 N/25 mm or less and further preferably 18 N/25 mm or less.

The above adhesive strength refers basically to a peel strength that is measured using a method of 180° peeling in accordance with JIS 20237: 2009, and a specific testing method is as described in the Testing Example, which will be described later.

### (3) Surface Resistivity

In the case in which the pressure sensitive adhesive composition P contains the previously described antistatic, when a voltage of 100 V is applied to the adhesive sheet 1 (adhesive layer/release sheets) according to the present embodiment for 10 seconds under an environment of 23° C. and 50% RH, the surface resistivity of the exposed surface of the pressure sensitive adhesive layer may be preferably 1.0×10¹³ Ω/sq or less, more preferably 5.0×10¹² Ω/sq or less, particularly preferably 1.0×10¹² Ω/sq or less, and further preferably 5.0×10¹¹ Ω/sq or less as the upper limit. When the upper limit of the above surface resistivity is as the above, excellent antistatic properties can be exhibited, and it is possible to suppress adhesion of dust due to the electrostatic action and/or adverse electrical effects on an adherend. The lower limit of the above surface resistivity is not particularly limited, but may be preferably about 1.0×10¹⁰ Ω/sq or more. Measurement of the surface resistivity of the pressure sensitive adhesive layer is performed in accordance with JIS K6911: 2006, and is specifically as described in the Testing Example, which will be described later.

### 3. Production of Pressure Sensitive Adhesive Sheet

An example of producing the adhesive sheet 1 may include coating the release surface of one release sheet 12a (or 12b) with a coating solution of the above pressure sensitive adhesive composition P, performing heat treatment to thermally crosslink the pressure sensitive adhesive composition P to form a coating layer, and then overlapping the release surface of the other release sheet 12b (or 12a) on the coating layer. When an aging period is necessary, the above coating layer may become the pressure sensitive adhesive layer 11 after the aging period passes, while when an aging period is not necessary, the above coating layer formed as such may be the pressure sensitive adhesive layer 11. The above pressure sensitive adhesive sheet 1 can thus be obtained. Conditions for the heat treatment and aging are as previously described.

Another example of producing the adhesive sheet 1 may include coating the release surface of one release sheet 12a with a coating solution of the above pressure sensitive adhesive composition P and performing heat treatment to thermally crosslink the pressure sensitive adhesive composition P to form a coating layer, thus obtaining the release sheet 12a with the coating layer. The example may further include coating the release surface of the other release sheet 12b with the coating solution of the above pressure sensitive adhesive composition P and performing heat treatment to thermally crosslink the pressure sensitive adhesive composition P to form a coating layer, thus obtaining the release sheet 12b with the coating layer. Then, the release sheet 12a with the coating layer and the release sheet 12b with the coating layer are bonded so that both the coating layers are in contact with each other. When an aging period is necessary, the above laminated coating layers may become the pressure sensitive adhesive layer 11 after the aging period passes, while when an aging period is not necessary, the above laminated coating layers formed as such may be the pressure sensitive adhesive layer 11. The above pressure sensitive adhesive sheet 1 can thus be obtained. According to this production example, even when the pressure sensitive adhesive layer 11 is thick, stable production is possible.

Examples of the method of coating with the above coating solution of the pressure sensitive adhesive composition P include a bar coating method, a knife coating method, a roll coating method, a blade coating method, a die coating method, and a gravure coating method.

### <Laminate>

The laminate according to an embodiment of the present invention includes two display body structural members and a pressure sensitive adhesive layer interposed between the two display body structural members, and the pressure sensitive adhesive layer is formed of the previously described pressure sensitive adhesive layer of the adhesive sheet. This laminate is a display body (display panel) or a member thereof.

At least one of the above display body structural members may preferably include a plastic plate. Unlike a glass plate, a plastic plate causes outgassing under high temperature and high humidity conditions and transmits water vapor. This may generally cause blisters such as air bubbles, floating, and delamination between the plastic plate and the pressure sensitive adhesive layer. Fortunately, however, in the laminate according to the present embodiment, the use of the previously described pressure sensitive adhesive layer of the adhesive sheet suppresses the occurrence of blisters such as air bubbles, floating, and delamination even when placed under high temperature and high humidity conditions (e.g., 85° C., 85% RH, 96 hours).

FIG. 2 illustrates a specific configuration as an example of the laminate according to the present embodiment.

As illustrated in FIG. 2, a laminate 2 according to the present embodiment includes a first display body structural member 21, a second display body structural member 22, and a pressure sensitive adhesive layer 11 that is located and interposed between the first display body structural member 21 and the second display body structural member 22. In the laminate 2 according to the present embodiment, the first display body structural member 21 has steps on the surface on the pressure sensitive adhesive layer 11 side, specifically steps due to the presence or absence of printed layers 3.

The laminate 2 may be, for example, a member that constitutes a part of a display body such as a liquid crystal (LCD) display, a light emitting diode (LED) display, an organic electroluminescence (organic EL) display, or electronic paper or may also be the display body itself. The display body may be a touch panel.

The pressure sensitive adhesive layer 11 in the above laminate 2 may be formed of the previously described pressure sensitive adhesive layer 11 of the adhesive sheet 1 and may be preferably the pressure sensitive adhesive layer 11 itself.

The first display body structural member 21 and the second display body structural member 22 are not particularly limited, provided that the pressure sensitive adhesive layer 11 can be adhered thereto. The first display body structural member 21 and the second display body structural member 22 may be made of the same material or may also be made of different materials.

Specifically, the first display body structural member 21 may be preferably a protective panel made of a plastic plate or a laminate including a plastic plate.

The plastic plate is not particularly limited, and examples thereof include acrylic resin plates such as a polycarbonate resin (PC) plate and a polymethyl methacrylate resin (PMMA) plate and plastic plates obtained by laminating an acrylic resin layer such as a polymethyl methacrylate resin layer on a polycarbonate resin plate. The above polycarbonate resin plate may contain a resin other than polycarbonate resin as a material that constitutes the polycarbonate resin plate, and the above acrylic resin plate may contain a resin other than acrylic resin as a material that constitutes the acrylic resin plate.

The thickness of the plastic plate is not particularly limited, but may be usually 0.2 to 5 mm, preferably 0.4 to 3 mm, particularly preferably 0.6 to 2.5 mm, and further preferably 0.8 to 2.1 mm.

One or both surfaces of the above plastic plate may be provided with various functional layers (such as a transparent conductive film, a metal layer, a silica layer, a hard coat layer, an antiglare layer, and an ultraviolet absorption layer) or may also be formed with metal wirings. The transparent conductive film and the metal layer may be patterned.

The second display body structural member 22 is not particularly limited, but examples thereof include a desired optical member, a display body module, and a member of the display body module.

Examples of the above optical member include an anti-scattering film, a polarizing plate (polarizing film), a polarizer, a retardation plate (retardation film), a viewing angle compensation film, a brightness enhancement film, a contrast enhancement film, a liquid crystal polymer film, a diffusion film, a transflective film, and a transparent conductive film. Examples of the anti-scattering film include a hard coat film in which a hard coat layer is formed on one surface of a base material film.

The above optical member may be a glass plate or a laminated member including a glass plate. The glass plate is not particularly limited, and examples thereof include chemically strengthened glass, non-alkali glass, quartz glass, soda-lime glass, barium/strontium-containing glass, aluminosilicate glass, lead glass, borosilicate glass, and barium borosilicate glass.

The thickness of the glass plate is not particularly limited, but may be usually 0.1 to 10 mm, preferably 0.2 to 8 mm, more preferably 0.8 to 4 mm, and particularly preferably 1 to 2 mm.

Examples of the above display body module include a liquid crystal (LCD) module, a light emitting diode (LED) module, an organic electroluminescence (organic EL) module, and electronic paper. The above-described glass plates, plastic plates, optical members, or the like may be usually laminated on these display body modules. For example, a polarizing plate is laminated on an LCD module, and the polarizing plate forms one surface of the LCD module.

The material which constitutes the printed layers 3 is not particularly limited, and known materials for printing may be used. The lower limit of the thickness of the printed layers 3, that is, the lower limit of the height of steps, may be preferably 3 μm or more, more preferably 7.5 μm or more, and particularly preferably 10 μm or more. When the lower limit is not less than the above, it is possible to sufficiently ensure the concealability such as making the electric wiring invisible from the viewer side. From another aspect, the upper limit may be preferably thinner than the thickness of the pressure sensitive adhesive layer, more preferably 80 μm or less, particularly preferably 50 μm or less, and further preferably 25 μm or less. When the upper limit is not larger than the above, it is possible to prevent the pressure sensitive adhesive layer 11 from deteriorating in the followability to the printed layers 3. In general, the printed layers 3 may be formed in the shape of a frame on the pressure sensitive adhesive layer 11 side of the display body structural members.

To produce the above laminate 2, in an example, one release sheet 12a of the adhesive sheet 1 is removed, and the exposed pressure sensitive adhesive layer 11 of the adhesive sheet 1 is bonded to the surface on the side on which the printed layers 3 of the first display body structural member 21 are present.

Then, the other release sheet 12b is removed from the pressure sensitive adhesive layer 11 of the adhesive sheet 1, and the exposed pressure sensitive adhesive layer 11 of the adhesive sheet 1 and the second display body structural member 22 are bonded to each other to obtain a laminate. In another example, the bonding order of the first display body structural member 21 and the second display body structural member 22 may be changed.

The pressure sensitive adhesive layer 11 in the above laminate 2 is excellent in the blister resistance, so even when the laminate 2 is placed, for example, under a condition of 85° C. and 85% RH for 96 hours, the occurrence of air bubbles, floating, delamination, etc. is suppressed at the interface between the pressure sensitive adhesive layer 11 and each of the display body structural members 21 and 22.

<Pressure Sensitive Adhesive Sheet according to Second Embodiment>

The adhesive sheet according to the second embodiment includes at least a pressure sensitive adhesive layer, and a pressure sensitive adhesive that constitutes the pressure sensitive adhesive layer is formed of a pressure sensitive adhesive composition that contains a (meth)acrylic ester polymer (A).

The (meth)acrylic ester polymer (A) in the adhesive sheet according to the present embodiment contains, as a monomer unit that constitutes the polymer, a carbon dioxide-derived monomer obtained using carbon dioxide as a raw material. This allows the adhesive sheet according to the second embodiment to consume carbon dioxide as a raw material, and this can contribute to the reduction of carbon dioxide, which is an internationally important issue, and accordingly to the Sustainable Development Goals (SDGs) adopted by the United Nations.

When producing the above carbon dioxide-derived monomer, for 1 mol of the carbon dioxide-derived monomer, preferably 0.1 mol or more of carbon dioxide may be consumed, more preferably 0.4 mol or more may be consumed, particularly preferably 0.8 mol or more may be consumed, further preferably 0.9 mol or more may be consumed, and most preferably 1 mol or more may be consumed. This can effectively contribute to the reduction of carbon dioxide. The upper limit is not particularly limited, but the consumption may be preferably 2 mol or less, particularly preferably 1.5 mol or less, and further preferably 1.2 mol or less.

The above carbon dioxide-derived monomer may be preferably obtained by reacting an epoxy group-containing compound and carbon dioxide. Examples of such carbon dioxide-derived monomers include ethylene carbonate-containing monomers. Among these, the previously described ethylene carbonate-containing monomer may be preferred, and (2-oxo-1,3-dioxolan-4-yl)methyl methacrylate may be particularly preferred from the viewpoint of excellent blister resistance.

The adhesive sheet according to the second embodiment is the same as the adhesive sheet according to the first embodiment except for the above matters. A laminate obtained by using the adhesive sheet according to the second embodiment is also the same as the laminate according to the above embodiment.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

For example, one or both of the release sheets 12a and 12b in the adhesive sheet 1 may be omitted, and one or more desired display body structural members may be laminated as substitute for the release sheets 12a and/or 12b. Moreover, the first display body structural member 21 may not have the printed layers 3 (steps) or may have one or more steps other than the printed layers 3. Furthermore, not only the first display body structural member 21 but also the second display body structural member 22 may have one or more steps on the pressure sensitive adhesive layer 11 side.

### EXAMPLES

Hereinafter, the present invention will be described further specifically with reference to examples, etc., but the scope of the present invention is not limited to these examples, etc.

### Example 1

### 1. Preparation of (Meth)acrylic Ester Polymer (A)

The (meth)acrylic ester polymer (A) was prepared by using a solution polymerization method to copolymerize 98 mass parts of n-butyl acrylate, 1 mass part of (2-oxo-1,3-dioxolan-4-yl)methyl methacrylate as an ethylene carbonate-containing monomer, and 1 mass part of 4-hydroxybutyl acrylate. The molecular weight of the (meth)acrylic ester polymer (A) was measured by the method, which will be described later. The weight-average molecular weight (Mw) was 750,000.

### 2. Preparation of Pressure Sensitive Adhesive Composition

The coating solution of a pressure sensitive adhesive composition was obtained through mixing and sufficiently stirring 100 mass parts (solid content equivalent, here and hereinafter) of the (meth)acrylic ester polymer (A) obtained in the above step 1 and 0.26 mass parts of trimethylol propane-modified xylylene diisocyanate (available from Soken Chemical & Engineering Co., Ltd., product name “TD-75”) as the crosslinker (B) and diluting the mixture with methyl ethyl ketone.

### 3. Production of Pressure Sensitive Adhesive Sheet

The release-treated surface of a tight release sheet (available from LINTEC Corporation, product name “SP-PET382150”) obtained by release-treating one surface of a polyethylene terephthalate film with a silicone-based release agent was coated with the obtained coating solution of the pressure sensitive adhesive composition by using a knife coater. Then, the coating solution was heat-treated at 90° C. for 1 minute to form a coating layer.

Subsequently, the coating layer on the tight release sheet obtained as above and an easy release sheet (available from LINTEC Corporation, product name “SP-PET381130”) obtained by release-treating one surface of a polyethylene terephthalate film with a silicone-based release agent were bonded to each other so that the release-treated surface of the easy release sheet was in contact with the coating layer, and aged under a condition of 23° C. and 50% RH for 7 days to produce an adhesive sheet having a pressure sensitive adhesive layer of a thickness of 25 μm, i.e., an adhesive sheet having a configuration of tight release sheet/pressure sensitive adhesive layer (thickness: 25 μm)/easy release sheet.

The thickness of the pressure sensitive adhesive layer is a value measured using a constant-pressure thickness meter (available from TECLOCK Co., Ltd., product name “PG-02”) in accordance with JIS K7130.

Here, Table 1 lists the formulations (solid content equivalents) of the pressure sensitive adhesive compositions when the (meth)acrylic ester polymer (A) is 100 mass parts (solid content equivalent). Details of the simplified names listed in Table 1 and additional information are as follows.

### <(Meth)acrylic Ester Polymer (A)>

BA: n-butyl acrylate

CARBOM: (2-oxo-1,3-dioxolan-4-yl)methyl methacrylate

4HBA: 4-hydroxybutyl acrylate

2EHA: 2-ethylhexyl acrylate

HEA: 2-hydroxyethyl acrylate

MMA: methyl methacrylate

### <Crosslinker (B)>

Trimethylolpropane-modified xylylene diisocyanate (available from Soken Chemical & Engineering Co., Ltd., product name “TD-75”)

### <Antistatic>

Lithium bis(trifluoromethanesulfonyl)imide

### Examples 2 to 5 and Comparative Examples 1 and 2

Pressure sensitive adhesive sheets were produced in the same manner as in Example 1 except that the type and ratio of each monomer constituting the (meth)acrylic ester polymer (A), the weight-average molecular weight (Mw) of the (meth)acrylic ester polymer (A), the compounding amount of the crosslinker (B), and the compounding amount of the antistatic were as listed in Table 1.

The previously described weight-average molecular weight (Mw) refers to a weight-average molecular weight that is measured as a polystyrene equivalent value under the following condition using gel permeation chromatography (GPC) (GPC measurement).

### <<Measurement Condition>>

GPC measurement device: HLC-8020 available from Tosoh Corporation
GPC columns (passing through in the following order): available from Tosoh Corporation

TSK guard column HXL-H

TSK gel GMHXL (×2)

TSK gel G2000HXL
Solvent for measurement: tetrahydrofuran
Measurement temperature: 40° C.

### <Testing Example 1> (Measurement of Gel Fraction)

Each of the adhesive sheets produced in Examples and Comparative Examples was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 24 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the mesh itself. The mass at that time is M2. The gel fraction (%) is represented by (M2/M1)×100. Through this operation, the gel fraction of the pressure sensitive adhesive was derived. The results are listed in Table 2.

### <Testing Example 2> (Measurement of Dynamic Viscoelasticity)

The release sheets were removed from each of the adhesive sheets produced in Examples and Comparative Examples, and a plurality of pressure sensitive adhesive layers was laminated to have a thickness of 0.8 mm. A cylindrical body (height of 0.8 mm) having a diameter of 8 mm was punched out from the obtained laminate of the pressure sensitive adhesive layers, and this was used as a sample.

For the above sample, the dynamic viscoelasticity was measured by a torsional shear method in accordance with JIS K7244-1 using a viscoelasticity measurement device (available from Anton Paar, product name “MCR302”) under the following condition, and the storage elastic modulus (G′) (MPa) at 25° C. and 85° C. and the loss tangent (tan δ) at 25° C. and 85° C. were measured. The results are listed in Table 2.

Measurement frequency: 1 Hz

Measurement temperature range: 0° C. to 100° C.

Heating rate: 3° C./min

### <Testing Example 3> (Calculation of Dielectric Constant)

The pressure sensitive adhesive layer of the adhesive sheet produced in each of Examples and Comparative Examples was laminated on one surface of a polyethylene terephthalate film having a thickness of 50 μm to form a pressure sensitive adhesive layer having a thickness of 0.8 mm, on which another polyethylene terephthalate film having a thickness of 50 μm was bonded, and they were cut into 50 mm×50 mm. A capacitance (C1) of the obtained laminate was measured using an impedance analyzer (available from KEYCOM Corporation, product name “HP4194A”). In addition, the above two polyethylene terephthalate films having a thickness of 50 μm were stacked and cut into 50 mm×50 mm, and a capacitance (C2) was measured in the same manner. Then, a capacitance (C3) of the pressure sensitive adhesive was calculated by subtracting C2 from C1. On the basis of the capacitance C3, a dielectric constant εₛ of the pressure sensitive adhesive was calculated from the following formula. The results are listed in Table 2.

εₛ=(C3×d)/(ε₀×S)

εₛ: Dielectric constant of pressure sensitive adhesive

ε₀: Dielectric constant of vacuum (8.854×10⁻¹²)

C3: Capacitance of pressure sensitive adhesive

S: Area of pressure sensitive adhesive layer

d: Thickness of pressure sensitive adhesive layer

### <Testing Example 4> (Measurement of Surface Resistivity)

The easy release sheet was removed from the adhesive sheet prepared in each of Examples and Comparative Examples, and the surface resistivity of the exposed pressure sensitive adhesive surface of the pressure sensitive adhesive layer was measured in accordance with JIS K6911: 2006. Specifically, under an environment of 23° C. and 50% RH, the surface resistivity (Q/sq) of the pressure sensitive adhesive surface of the pressure sensitive adhesive layer was measured using a resistivity measurement device (available from Nittoseiko Analytech Co., Ltd., product name “Hiresta UP MCP-HT450”) after applying a voltage of 100 V for 10 seconds to the adhesive sheet (100 mm×100 mm) from which the easy release sheet was removed. The results are listed in Table 2.

### <Testing Example 5> (Tensile Test)

A plurality of the above pressure sensitive adhesive layers in the adhesive sheets produced in each of Examples and Comparative Examples was laminated so that the total thickness of the pressure sensitive adhesive layers was 500 μm and only the release sheets of the outermost layers remained, and was left untouched for 24 hours under an atmosphere of 23° C. and 50% RH. After that, a sample of 10 mm width×75 mm length was cut out from the adhesive sheets in which the above plurality of the pressure sensitive adhesive layers was laminated, the release sheets laminated on the outermost layers were removed, the sample was set so as to have a sample measurement site of 10 mm width×20 mm length (extending direction) and extended until it broke at a tensile speed of 200 mm/min under an environment of 23° C. and 50% RH using a tensile tester (available from ORIENTEC Co., LTD., product name “TENSILON”), and the breaking elongation (%) was determined from the obtained stress-strain curve. In addition, the film strength (N/mm²) was calculated by dividing the stress at break (breaking stress; N) by the cross-sectional area (5 mm²) of the above sample. Furthermore, the breaking energy (J) was calculated by integrating the obtained stress-strain curve from the initial point to the breaking point. The results are listed in Table 2.

### <Testing Example 6> (Measurement of Adhesive Strength)

The easy release sheet was removed from each of the adhesive sheets produced in Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET TA063,” thickness: 100 μm) to obtain a laminate of tight release sheet/pressure sensitive adhesive layer/PET film. The obtained laminate was cut into a width of 25 mm and a length of 100 mm.

The tight release sheet was removed from the above laminate under an environment of 23° C. and 50% RH, and the exposed pressure sensitive adhesive layer was bonded to each of the following three adherends and pressurized in an autoclave available from KURIHARA SEISAKUSHO Co., Ltd. at 0.5 MPa and 50° C. for 20 minutes. After that, the obtained sample was left untouched under a condition of 23° C. and 50% RH for 24 hours, and then the adhesive strength (N/25 mm) when the laminate of the PET film and the pressure sensitive adhesive layer was peeled off from the adherend was measured under a condition of a peel speed of 300 mm/min and a peel angle of 180° by using a tensile tester (available from ORIENTEC Co., LTD., product name “TENSILON”). The measurement was conducted in accordance with JIS 20237: 2009 except for the condition described herein. The results are listed in Table 2.

### <<Adherends>>

Soda-lime glass plate (available from Nippon Sheet Glass Company, Ltd., product name “Soda-lime glass,” thickness: 1.1 mm)
Non-alkali glass plate (available from Nippon Sheet Glass Company, Ltd., product name “Eagle-X,” thickness: 1.1 mm)
Polycarbonate plate (available from MITSUBISHI GAS CHEMICAL COMPANY, INC., product name “Iupilon Sheet MR58U,” thickness: 0.8 mm)

### <Testing Example 7> (Evaluation of Blister Resistance)

The easy release sheet was released from each of the adhesive sheets produced in Examples and Comparative Examples, and the exposed pressure sensitive adhesive layer was bonded to the ITO surface side of a tin-doped indium oxide (ITO)-deposited polyethylene terephthalate (PET) film (available from OIKE & Co., Ltd., product name “TETOLIGHT TCF,” thickness: 188 μm) to obtain an ITO-deposited PET film with a pressure sensitive adhesive layer.

The tight release sheet was removed from the ITO-deposited PET film with the pressure sensitive adhesive layer obtained above, and the exposed pressure sensitive adhesive layer was bonded to the PC plate side of a plastic plate in which a polymethyl methacrylate (PMMA) layer was laminated on a polycarbonate (PC) plate (available from MITSUBISHI GAS CHEMICAL COMPANY, INC., product name “Iupilon Sheet MR58U,” thickness: 0.8 mm). It was then autoclaved under a condition of 50° C. and 0.5 MPa for 20 minutes and left untouched at normal pressure at 23° C. and 50% RH for 24 hours.

After that, it was stored for 12 hours and 96 hours under a high temperature and high humidity condition of 85° C. and 85% RH (durability test). Then, the state of the interface between the pressure sensitive adhesive layer and the adherend (ITO-deposited PET film, plastic plate) was visually confirmed, and the blister resistance was evaluated in accordance with the following criteria. The results are listed in Table 2.

∘ . . . There was no air bubble or floating/delamination.

Δ . . . Air bubbles and/or floating/delamination occurred partially.

x . . . Floating/delamination occurred over a wide area.

In Comparative Examples 1 and 2, the evaluation in the 96-hour durability test was not conducted because the evaluation in the 12-hour durability test was x.

TABLE 1

| | | | Crosslinker | Anti- |
|---|---|---|---|---|
| | | | (B) | static |
| | (Meth)acrylic ester polymer (A) | | mass | mass |
| | Composition | Mw | parts | parts |
| Example 1 | BA/CARBOM/4HBA = | 750,000 | 0.26 | — |
| | 98/1/1 | | | |
| Example 2 | 8A/CARBOM/4HBA = | 750,000 | 0.26 | — |
| | 94/5/1 | | | |
| Example 3 | BA/CARBOM/4HBA = | 750,000 | 0.26 | — |
| | 84/15/1 | | | |
| Example 4 | BA/CARBOM/4HBA = | 750,000 | 0.22 | 0.5 |
| | 84/15/1 | | | |
| Example 5 | 2EHA/CARBOM/HEA = | 600,000 | 0.23 | — |
| | 60/20/20 | | | |
| Comparative | BA/4HBA = | 750,000 | 0.26 | — |
| Example 1 | 99/1 | | | |
| Comparative | 2EHA/MMA/HEA = | 700,000 | 0.23 | — |
| Example 2 | 60/20/20 | | | |

TABLE 2

| | Gel | Storage elastic | | | | Dielectric | Surface | Breaking |
|---|---|---|---|---|---|---|---|---|
| | fraction | modulus (MPa) | | Loss tangent | | constant | resistivity | elongation |
| | (%) | 25° C. | 85° C. | 25° C. | 85° C. | (∈ [symbol] ) | (Ω/sq) | (%) |
| Example 1 | 63 | 0.05 | 0.01 | 0.39 | 0.46 | 6.00 | >10¹³ | 1482 |
| Example 2 | 58 | 0.06 | 0.02 | 0.39 | 0.46 | 6.78 | >10¹³ | 1307 |
| Example 3 | 56 | 0.10 | 0.02 | 0.69 | 0.44 | 6.74 | >10¹³ | 1008 |
| Example 4 | 54 | 0.14 | 0.03 | 0.67 | 0.45 | 6.11 | 3.9 × 10¹¹ | 1061 |
| Example 5 | 71 | 0.29 | 0.03 | 1.14 | 0.42 | 6.09 | >10¹³ | 599 |
| Comparative | 65 | 0.03 | 0.01 | 0.36 | 0.37 | 5.68 | >10¹³ | 1246 |
| Example 1 | | | | | | | | |
| Comparative | 76 | 0.09 | 0.02 | 0.66 | 0.45 | 5.58 | >10¹³ | 657 |
| Example 2 | | | | | | | | |

| | | | Adhesive strength (N/25 mm) | | | | |
|---|---|---|---|---|---|---|---|
| | Film | Breaking | Against | Against | Against | | |
| | strength | energy | soda-lime | non-alkali | polycarbonate | Blister resistance | |
| | (N/mm²) | (J) | glass plate | glass plate | plate | 12 h | 96 h |
| Example 1 | 0.48 | 304 | 11 | 11 | 22 | ◯ | Δ |
| Example 2 | 0.66 | 343 | 14 | 15 | 15 | ◯ | ◯ |
| Example 3 | 0.95 | 532 | 14 | 17 | 13 | ◯ | ◯ |
| Example 4 | 0.83 | 595 | 21 | 19 | 16 | ◯ | ◯ |
| Example 5 | 2.19 | 955 | 19 | 19 | 17 | ◯ | ◯ |
| Comparative | 0.42 | 224 | 5 | 8 | 24 | X | — |
| Example 1 | | | | | | | |
| Comparative | 0.23 | 143 | 16 | 18 | 25 | X | — |
| Example 2 | | | | | | | |

[symbol]

indicates data missing or illegible when filed

As found from Table 2, the adhesive sheets produced in Examples were excellent in the blister resistance. Moreover, the adhesive sheets produced in Examples had high adhesive strength, especially to glass. Furthermore, the pressure sensitive adhesives in the adhesive sheets produced in Examples had a high dielectric constant.

### INDUSTRIAL APPLICABILITY

The adhesive sheet according to the present invention can be suitably used, for example, for bonding between a protective panel made of a plastic plate and a desired display body structural member.

### DESCRIPTION OF REFERENCE NUMERALS

1 Pressure sensitive adhesive sheet
11 Pressure sensitive adhesive layer
12a, 12b Release sheet
2 Laminate
21 First display body structural member
22 Second display body structural member
3 Printed layer

1. An adhesive sheet comprising at least a pressure sensitive adhesive layer, wherein
the adhesive sheet has an adhesive strength to soda-lime glass of larger than 1 N/25 mm and 100 N/25 mm or less,
a pressure sensitive adhesive that constitutes the pressure sensitive adhesive layer is formed of a pressure sensitive adhesive composition that contains a (meth)acrylic ester polymer (A), and
the (meth)acrylic ester polymer (A) contains, as a monomer unit that constitutes the polymer, an ethylene carbonate-containing monomer having an ethylene carbonate structure represented by Formula (1) below:

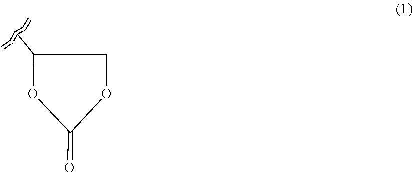

2. The adhesive sheet according to claim 1, wherein the (meth)acrylic ester polymer (A) contains 0.5 mass % or more and 40 mass % or less of the ethylene carbonate-containing monomer as the monomer unit that constitutes the polymer.

3. An adhesive sheet comprising at least a pressure sensitive adhesive layer, wherein
the adhesive sheet has an adhesive strength to soda-lime glass of larger than 1 N/25 mm and 100 N/25 mm or less,
the pressure sensitive adhesive layer is formed of a pressure sensitive adhesive composition that contains a (meth)acrylic ester polymer (A), and
the (meth)acrylic ester polymer (A) contains, as a monomer unit that constitutes the polymer, a carbon dioxide-derived monomer obtained using carbon dioxide as a raw material.

4. The adhesive sheet according to claim 3, wherein 0.1 mol or more of carbon dioxide is consumed for 1 mol of the carbon dioxide-derived monomer when producing the carbon dioxide-derived monomer.

5. The adhesive sheet according to claim 3, wherein the carbon dioxide-derived monomer is obtained by reacting an epoxy group-containing compound and carbon dioxide.

6. The adhesive sheet according to claim 1, wherein a pressure sensitive adhesive that constitutes the pressure sensitive adhesive layer has a storage elastic modulus (G′) at 25° C. of 0.01 MPa or more and 2 MPa or less.

7. The adhesive sheet according to claim 1, wherein a pressure sensitive adhesive that constitutes the pressure sensitive adhesive layer has a loss tangent (tan δ) at 25° C. of 0.3 or more and 3 or less, wherein the loss tangent (tan δ) at 25° C. is obtained from dynamic viscoelasticity measurement in accordance with JIS K7244-1.

8. The adhesive sheet according to claim 1, wherein a pressure sensitive adhesive that constitutes the pressure sensitive adhesive layer has a dielectric constant εₛ at 40 kHz of 5.8 or more and 10 or less.

9. The adhesive sheet according to claim 1, wherein the adhesive sheet comprises two release sheets, and
the pressure sensitive adhesive layer is interposed between the two release sheets so as to be in contact with release surfaces of the two release sheets.

10. A laminate comprising:
two display body structural members; and
a pressure sensitive adhesive layer interposed between the two display body structural members,
wherein the pressure sensitive adhesive layer is formed of the pressure sensitive adhesive layer of the adhesive sheet according to claim 1.

11. The laminate according to claim 10, wherein at least one of the display body structural members includes a plastic plate.
